(19) United States
(12) Patent Application Publication
(10) Pub. No.: US 2020/0117587 A1
(43) Pub. Date: Apr. 16, 2020

(54) Log File Analysis

(71) Applicant: HEWLETT PACKARD ENTERPRISE DEVELOPMENT LP, Houston, TX (US)

(72) Inventor: Muhammad Imran Salim, Houston, TX (US)

(21) Appl. No.: 16/160,216

(22) Filed: Oct. 15, 2018

(51) Int. Cl. G06F 11/36

(52) U.S. Cl. CPC G06F 11/3692; G06F 11/3664

(57) ABSTRACT

Disclosed is a method, system, and computer readable medium to implement differential log file analysis using a computer device. The differential technique including obtaining one or more log file entries representative of successful test executions of a computer process. The computer process may execute on a single computer system or be a distributed application across multiple computer systems in a target environment. Acceptable deviations between log file entries associated with different instances of successful test executions may be used to creating a pattern matching representation in the form of a line pattern, sequence pattern, timing pattern, branching sequence pattern, cyclical sequence pattern, or a combination thereof. Matching of run-time log file entries against known success acceptable patterns may provide indication of system or application anomalies based on a failed comparison of the matching. A state machine implementation may be used to perform the matching function.

### BACKGROUND

Log files are used in computer systems to store events and informational messages about system status and application status (among other things). This information may be automatically logged into a persistent storage log file on the device where the activity or event takes place or may be propagated to a central repository within a distributed system. Often log file entries include identification characteristics to allow determination of where, when, and what with respect to the information in the log file entry. For example, a log file entry may be formatted to include a timestamp, device identification, process or thread identification, port identification, application identification, or other type of information to provide context for the corresponding log file entry. Sometimes, log files are simply text files while other times log entries may be more sophisticated and stored in structured files (e.g., extensible markup language XML, hypertext markup language HTML). Further, sometimes log file entries may be stored in a relational data base or other type of indexable storage mechanism. In general, storage mechanisms may be centrally located where log file entries may be collected or may exist in distributed discrete log file storage across devices of a network. Accordingly, sometimes multiple device log files may be collected in a manner where there may be some sort of correlation between log file entries from different devices or they may be not correlated with other devices (or processes) at all as part of their collection. Multiple discrete log files may also be stored on a single device. For example, different applications or operational functions of a device may keep separate log files that may or may not have an inherent relationship with each other.

Analysis of log files represents a standard undertaking for system administrators as a mechanism to determine system anomalies. For example, after a computer device crash, a log file is typically one of the first places a system administrator may inspect to determine a cause for the crash. Sometimes, log file entries on a different device may also provide an indication of why another device may have crashed. System crashes are not the only reason a system administrator may wish to inspect log files. Other types of system anomalies or errors (including performance deviations) may be diagnosed with the help of log files. Manual collection and analysis of log files from different locations may be a time consuming process. Accordingly, techniques to improve log file analysis typically provide improvements for system administrators to perform their function in supporting a computer network of devices and applications. Log files are also used in performing tests (sometimes automated tests) of computer applications as part of their development. This function is typically supported by a quality assurance (QA) engineer. Accordingly, QA engineers, and other types of personnel that utilize log file analysis as part of their job function may also benefit from the techniques of this disclosure.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not require serial processing and therefore may be performed in an order different than shown or possibly in parallel with each other. For a detailed description of various examples, reference will now be made to the accompanying drawings, in which:

FIG. 1 is a functional block diagram of a distributed computer system of devices and applications, each of which may generate log file entries; and one example collection and analysis process for using automated collection, correlation, and analysis techniques to identify potential anomalies in the overall system according to one or more disclosed implementations;

FIG. 2 illustrates an example of line patterns for use in automated log file analysis, according to one or more disclosed implementations;

FIG. 3A illustrates an example of sequence patterns for use in automated log file analysis, according to one or more disclosed implementations;

FIG. 3B illustrates a code sample that may be used to identify branches as a type of sequence pattern that may appear in a log file, according to one or more disclosed implementations;

FIG. 3C illustrates a code sample that may be used to identify cycles as a type of sequence pattern that may appear in a log file, according to one or more disclosed implementations;

FIG. 4 illustrates an example for timing patterns for use in automated log file analysis, according to one or more disclosed implementations

FIG. 5 illustrates a flow chart as an example of different possible state machine implementations for use in automated log file analysis based on a differential analysis and success patterns, according to one or more disclosed implementations;

FIG. 6A is an example flowchart illustrating creation and use of inputs to a differential log file analysis state machine, according to one or more disclosed implementations;

FIG. 6B is an example flowchart illustrating one possible method of processing inputs to a differential log file analysis state machine and resulting state machine analysis, according to one or more disclosed implementations;

FIG. 7 is an example computing device with a hardware processor and accessible machine-readable instructions that might be used to perform differential log file analysis using success patterns and a state machine, according to one or more disclosed implementations;

FIG. 8 represents a computer network infrastructure that may be used to implement all or part of the disclosed differential log file analysis techniques as well as providing an example infrastructure where an implementation of disclosed techniques may be deployed, according to one or more disclosed implementations; and

FIG. 9 illustrates a computer processing device that may be used to implement the functions, modules, processing platforms, execution platforms, communication devices, and other methods and processes of this disclosure.

### DETAILED DESCRIPTION

Examples of the subject matter claimed below will now be disclosed. In the interest of clarity, not all features of an actual implementation are described in this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Disclosed techniques represent an improvement to the art of computer systems management and may improve productivity of system administrators. Further, use of disclosed techniques may result in an overall performance and reliability improvement for computing devices in a stand-alone or distributed environment by providing focus to identify potential system anomalies. In short, Differential Log Analysis provides techniques to narrow down and focus attention (e.g., of a system administrator or QA engineer) to suspected areas of any problems (e.g., errors or abnormal results) within one log file or a set of automatically correlated log files. In this context, a “problem” refers to information in a log file that may or may not be identified by the system as an error, however, a problem may be identified, in part, due to a deviation from one or more established patterns of Line, Sequences, and Timings that are expected to be present during log file analysis. Techniques disclosed are largely automated to alleviate manual inspection of potentially large amounts of information that may be necessarily present within log files. Thus, the automated analysis that is performed without requiring human involvement may make the overall process of log file analysis faster, less error prone, and more cost effective. These improvements may improve organizational performance in terms of developer time (e.g. for QA implementations), system administrator time (e.g., for system event management implementations), and/or improve customer experience (e.g., because of improved quality or error response time).

In general, standard differencing tools may not be adequate to compare log files representing an error condition with log files representing a successful execution. This is, in part, because log file entries may contain information expected to change from one execution cycle to another (e.g., a timestamp of when execution occurred). ‘Abnormal Patterns’ represent log entries which normally do not occur in successful run of an application or device in a given environment (e.g., target environment). Typical abnormal patterns are errors and warnings but may also be created by information messages or debug messages that may be optionally turned on or off over time. Further, even if content of log files does not reflect an error statement, the timing between log entries may, by itself, cause an abnormal pattern that may require further investigation (e.g., unusually large or unusually small time gaps between log entries). Some of the most difficult abnormal patterns to classify may include log messages that other techniques may identify as false warnings. Accordingly, disclosed techniques attempt to eliminate escalation (e.g., to a system administrator) of harmless errors, incorrectly coded information messages, and allowable deviation in timing patterns.

In the explanation of disclosed techniques, certain terms will be used to explain different concepts. However, other terms may be used by system administrators and QA engineers that refer to exactly the same or very similar concepts. Accordingly, these terms may not have a singular definition or consistent use within the field of quality assurance or system administration and should be interpreted based on their contextual use within this disclosure.

Line Patterns—

When attempting to identify line patters a comparison of individual lines from successful test runs may be used to generate “patterns of success” by attempting to make each line generic with respect to expected variations in successful lines. Comparison across different correlated portions of lines may be performed and replacement of values expected to have deviation may performed by inserting, for example, regular expressions such as *, ?, [1 . . . n] etc. These known “expected” line patters may later be compared with lines from failed tests, the differences may be used to reveal anomalous or unexpected data. In short, expected deviation in certain fields may be allowed while other, unexpected, deviations may indicate a need for further inspection.

Sequence Patterns—

In its simplest form a “Linear Sequence Pattern” represents line patterns of log entries along linear path of code execution. A sequence pattern refers to matching established line patterns of log line sequences against failed test logs in an attempt to identify unexpected additional information in a line or missing lines that are expected to be there. For example, an expected sequence of events is not presented in a log file when compared to known entry patterns of a proper sequence of events. This technique may identify either extra information (e.g., in the form of additional lines) or potentially missed information (e.g., for a missed status entry in a log file) for a known proper execution flow. The “sequence patterns” may exist in at least two different typical formats referred to as branches or cycles.

Branches—

Sequence patterns may be used to represent log entries along linear path of code execution. However, some code does not necessarily execute in linear path. Specifically, code often has “branches” based on conditional statements. Some conditional statements are “if-then-else” and “switch”. Other types of branches or non-sequential linear paths may also exist. As a result of different code execution paths, different log sequences (e.g., when conditional statements are executed) may be required because multiple branches could all be successful whereas some branches may represent error flows. Thus, Branching Patterns may be identified as a type of sequence pattern. Accordingly, patterns of success may include multiple ‘valid’ code paths.

Cycles—

Cycles may exist in a sequence pattern where repetitive log entries, representing a cyclic pattern, may be generated from iterative or recursive code blocks such as “for” and “while” loops. Cycles represent a second type of Sequence Pattern. In order to identify repetitive patterns, cycles should be detected in log sequences and where appropriate, identified as a success pattern.

Timing Patterns—

To extend upon sequence patterns, some log file entries may also have a temporal (e.g., time-based) correlation. It is almost always accepted practice that all log entries have date and time information associated with them, commonly known as “timestamp”. Accordingly, use of timing patterns may augment the above mentioned sequence patterns (linear, branch, or cyclic). In a timing pattern implementation, timing patterns between related (e.g., consecutive) log entries in successful test runs may be identified and stored for future comparison. Typical Timing Pattern analysis may involve a ‘delta-time’ that represents a time difference between two log entries in a log sequence. The ‘delta-time’ may be used to determine, for example, how fast or slow the code is executing. Thus, when any failed tests have log entries that are not temporally correlated (e.g., taking longer than usual or shorter than usual) in a manner consistent with expectation, the system may include this type of deviation as an indication of a problem area that deserves deeper analysis to identify a root cause or to determine the anomaly is not a concern.

Log Chains—

In real world systems, it is not uncommon for multiple threads of a single application, multiple applications, or even multiple systems to write to a single log file. The collected information in a single log file may therefore represent mixed entries from multiple sources. Specifically, applications or threads may go to sleep, wake up, or perform their functions based on scheduled states. This intermittent execution may also result in unpredictable and what would appear to be “out-of-sequence” writing to log files. Overall, this unpredictability creates potential complications when attempting to automatically “learn” the above referenced patterns of success impossible. In some implementations, this complication may be addressed by using available identifying information from log file entries (e.g., a thread-id, application-id, device-id, sequence-id, or timestamp) that may be present in information provided by the source (e.g., device, application, thread, etc.) generating the log file entry. These fields may be used to filter (de-interlace) log sequences that belong to a particular source. In this example, sequences that have been correlated together automatically will be referred to as “log-chains” (e.g., a chain or linked-list of log entries) such that there is a relationship between sequential log entries from a given source. In even more complex systems (e.g., higher volume of concurrent activity) such as web server environment, the http-request-id may also be used along with thread-id to identify log chains. That is, in some implementations, multiple identification fields may be used rather than a single field to create the above-mentioned log chain.

LogChainID—

In some implementations of this disclosure, a LogChainID (log chain identifier) may be used as a unique key to specifically identify an individual log chain. This identifier may be generated from ‘first’ line of Log Chain using a key such as [package: class: method-name: line-number].

Patterns of Success

Patterns of success have been briefly described above in the context of other terms. In general, the implementations of this disclosure refer to a pattern of success as any pattern that may be recognized by parsing log files from successful test runs in the target computer system environment (e.g., a Continuous Integration Environment). Recognized patterns may include one or more combinations of types described above, including but not limited to: Line, Sequence (Branching and Cyclic), and Timing patterns.

Multiple-Passing-Iterations-of-Same-Test—

In order to recognize patterns of success, log files from successful test runs (i.e., multiple runs through possibly many execution paths) may need to be collected. Multiple and sufficient number of successful log files may be used to: a) generate regular expression in line patterns, b) recognize valid code path execution sequential patterns, and c) Identify acceptable timing ranges for timing patterns. If a sufficient number of successful log files are not available, then recognized patterns may be incomplete or insufficient and provide only partial improvement. None the less, partial improvement may reduce effort required for overall log file analysis. Also note that parsing log files from failed tests may not be useful as a source for generating patterns of success, in part, because failed tests may be biased toward bad (e.g., error) patterns.

State Machine-based on Success Patterns—

In some implementations, a state machine that is based on the known patterns of success may be a useful technique for automating analysis of log entry information. In this example, a state machine may represent valid known code paths in the target environment. Thus, each state (represented as a node in a state machine) may be used to represent a log entry, the connections between nodes (sometimes referred to as edges) may be used to represent sequence patterns and a time may be associated with each edge to describe an expected time (usually a time range) for code to move from one state (node/log entry) to another.

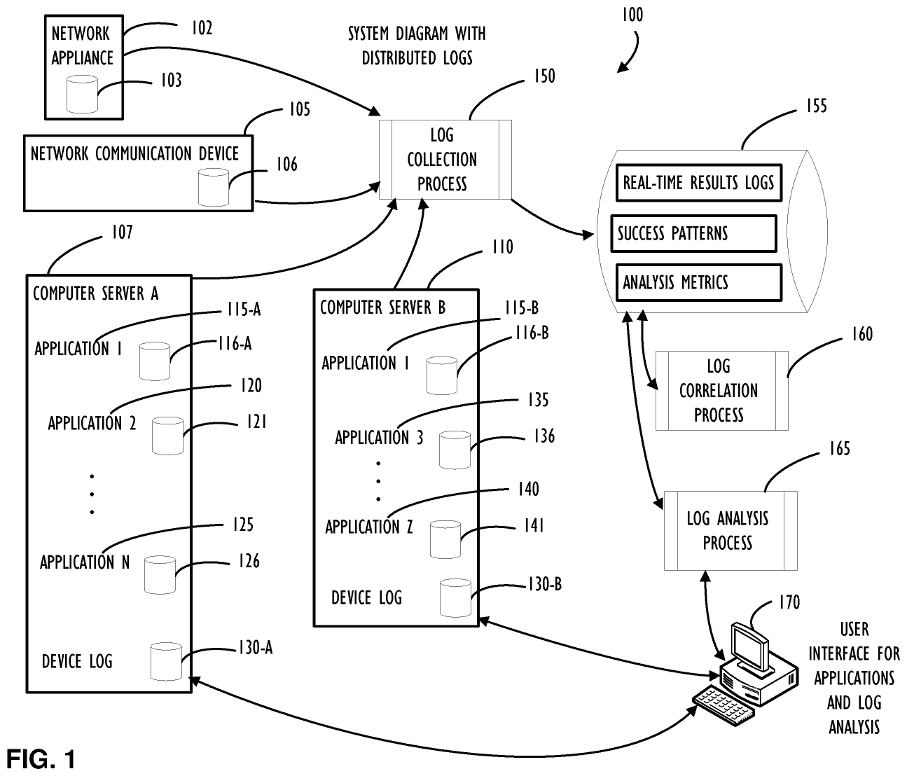

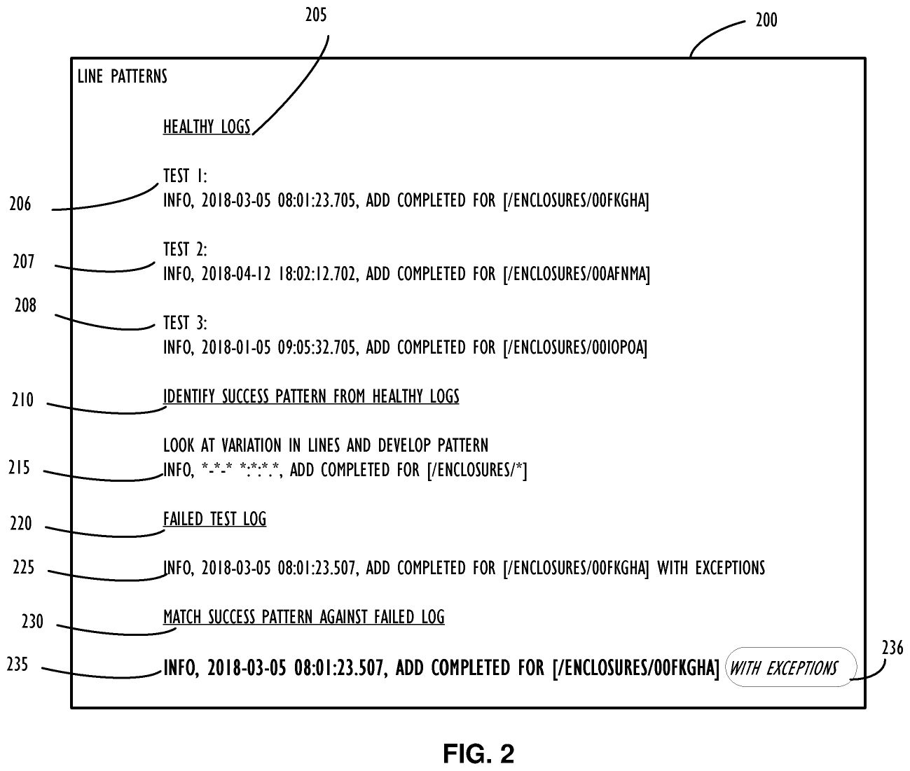

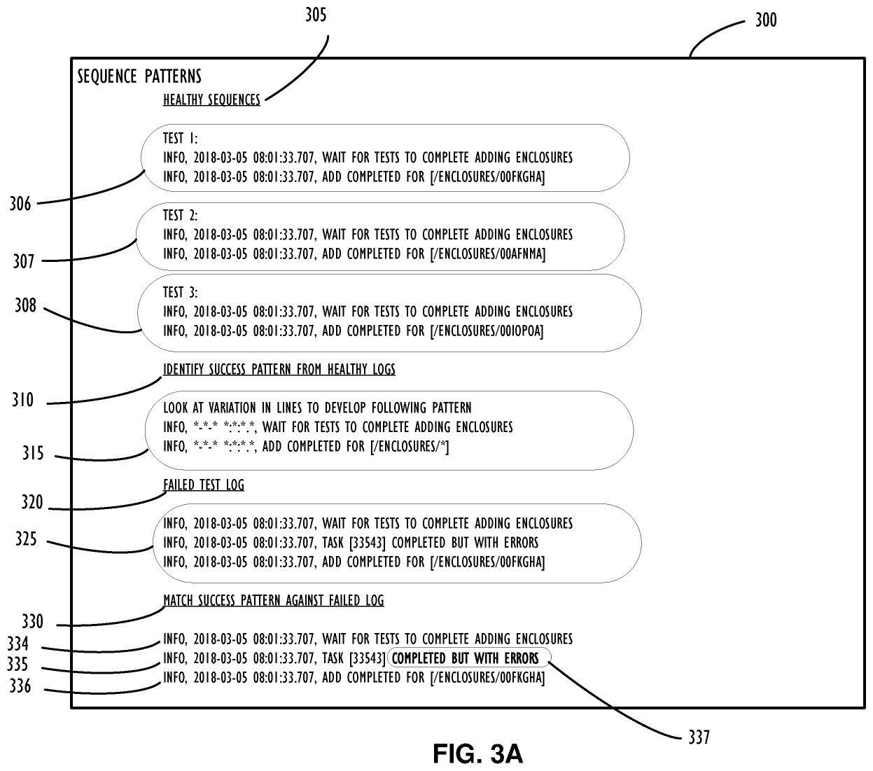

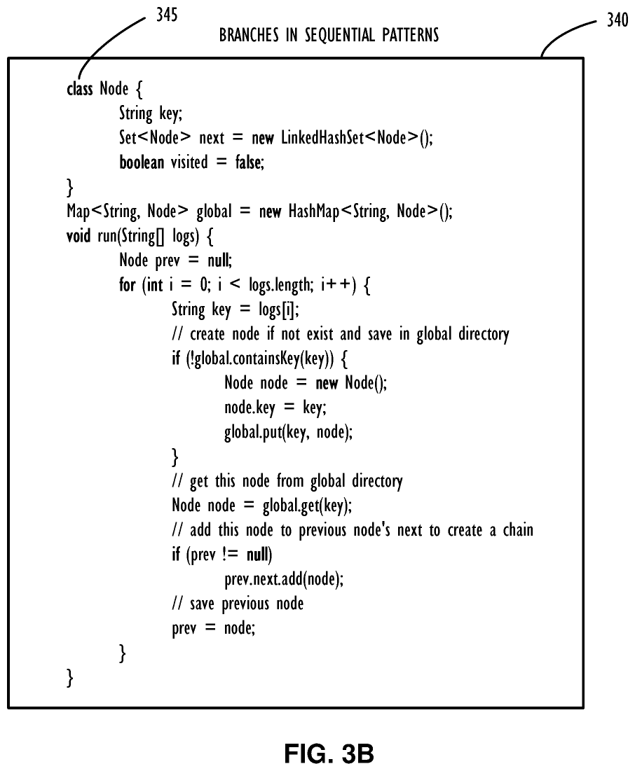

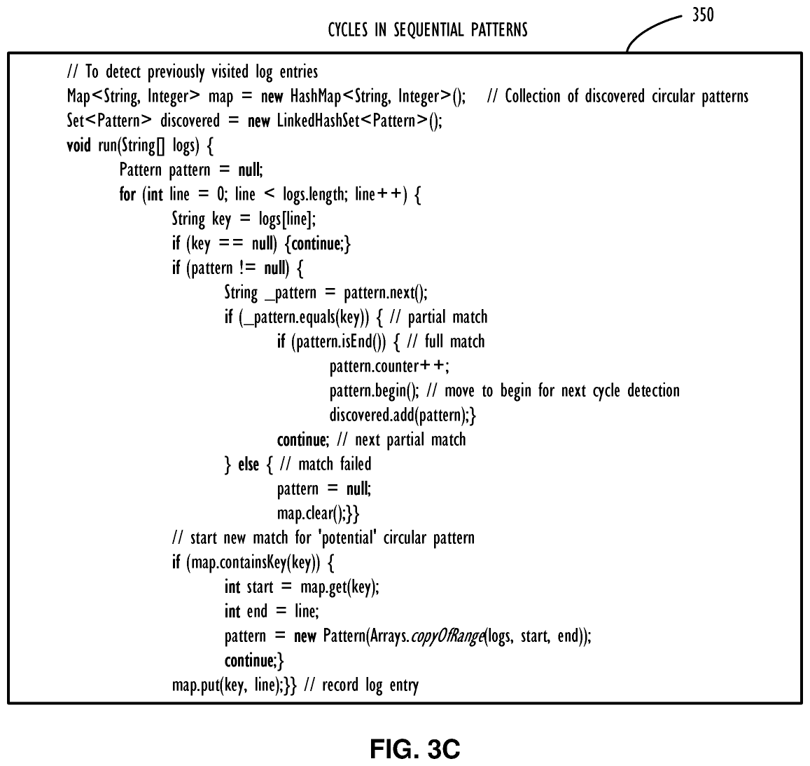

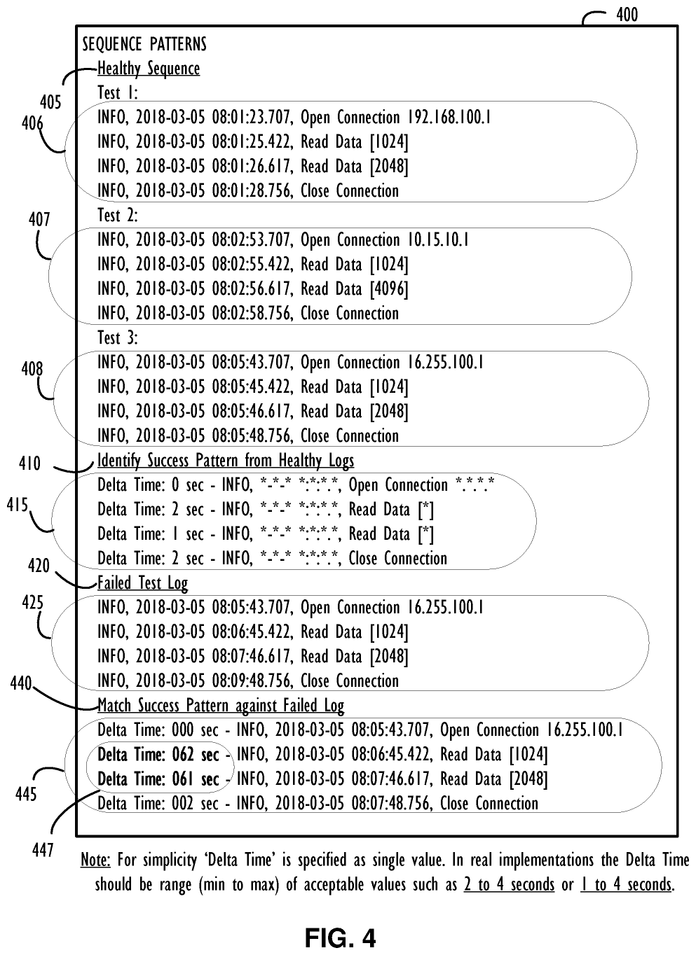

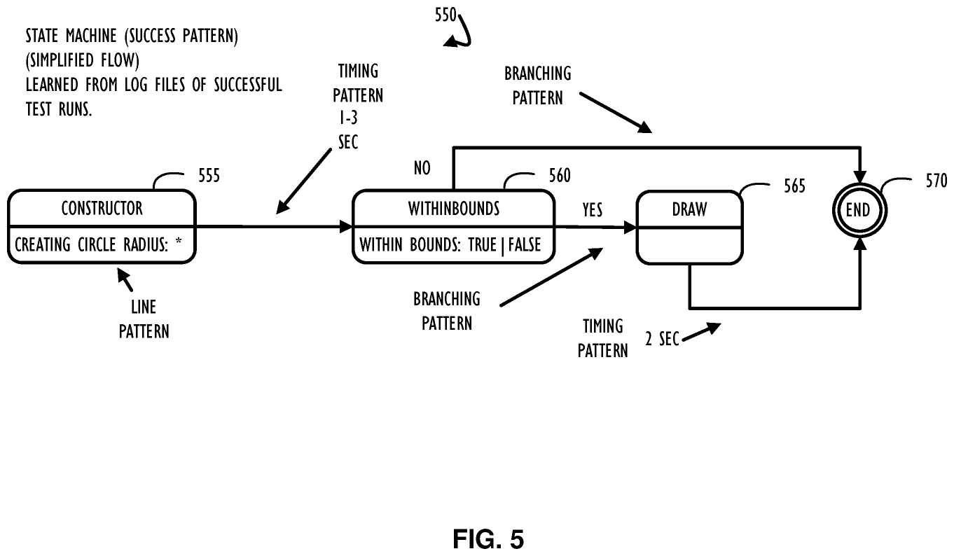

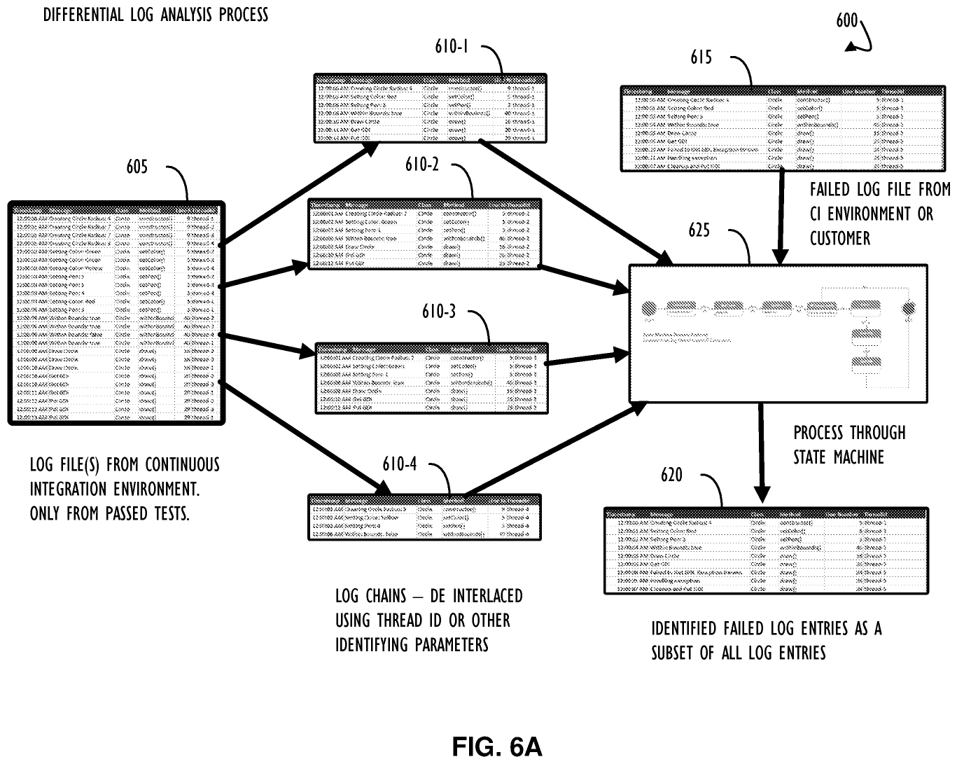

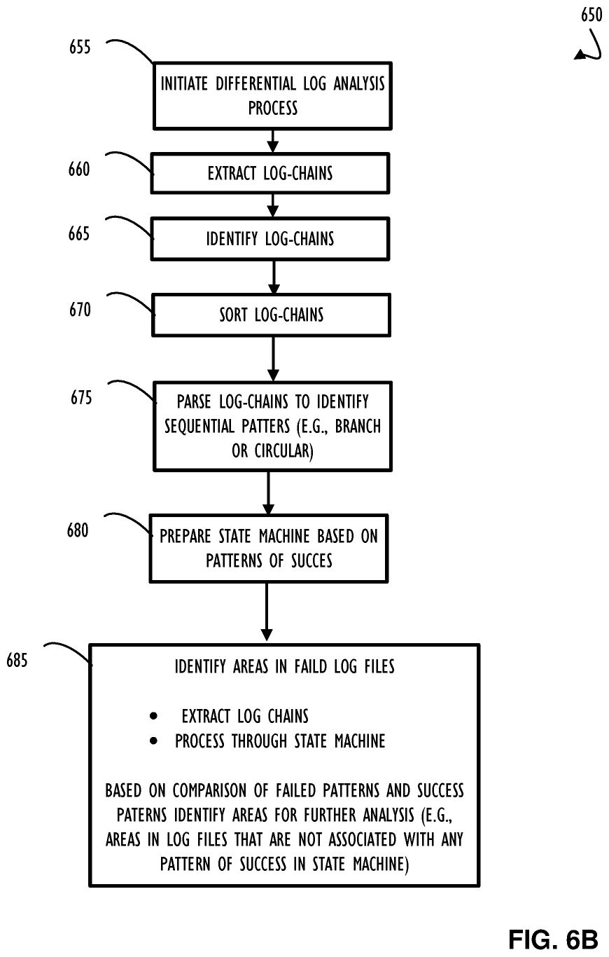

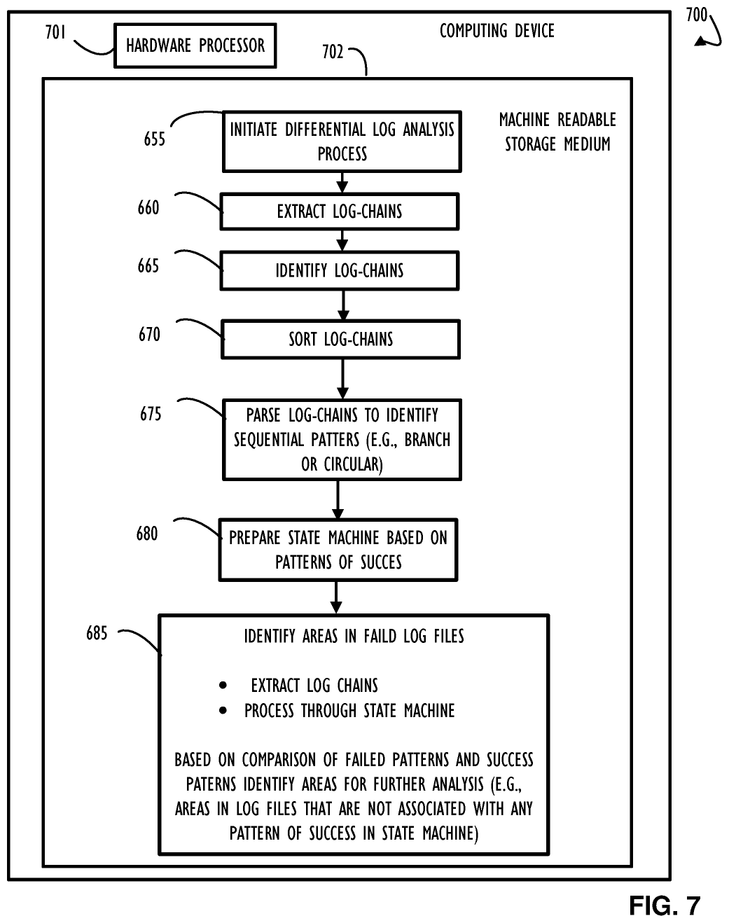

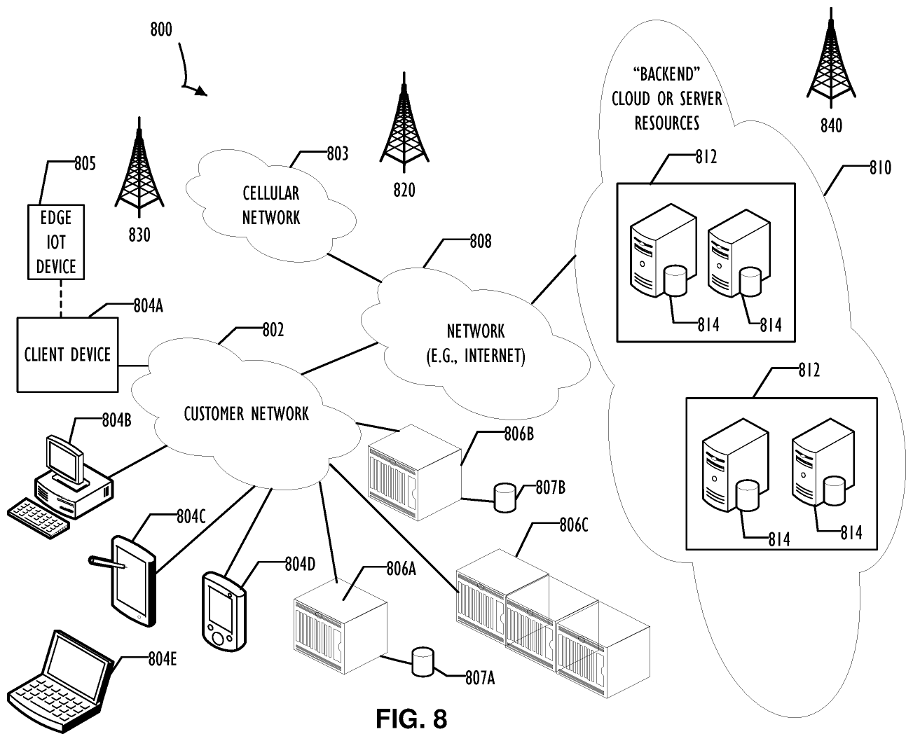

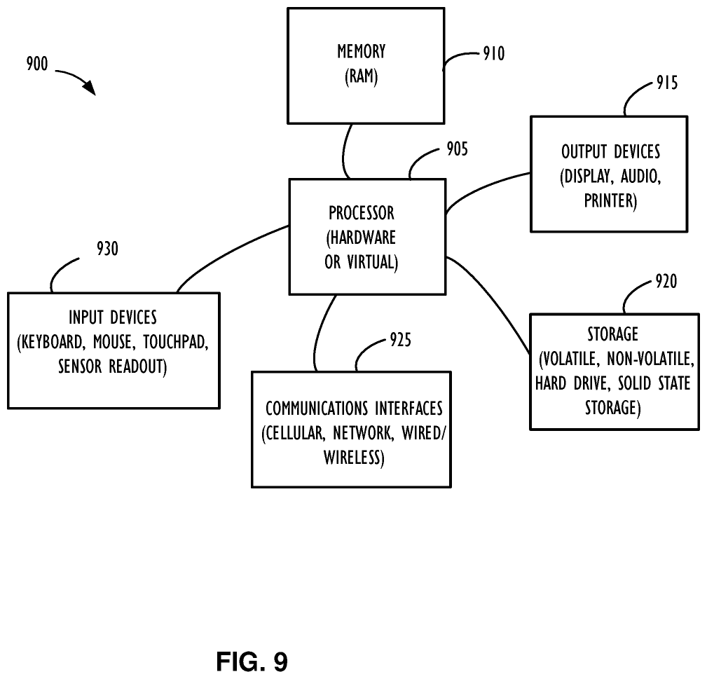

Having an understanding of the above overview, this disclosure will now explain a non-limiting but detailed example implementation of possible techniques to perform log file analysis based on known patterns of success. This example implementation is explained with reference to the figures which include: a functional block diagram of a distributed computer system of devices and applications, each of which may generate log file entries (FIG. 1); an example of line patterns (FIG. 2); an example of sequence patterns (FIG. 3A); a code sample that may be used to identify branches as a type of sequence pattern that may appear in a log file (FIG. 3B); a code sample that may be used to identify cycles as a type of sequence pattern that may appear in a log file (FIG. 3C); an example of timing pattern. (FIG. 4); a flow chart as an example of one or many different possible state machine implementations (FIG. 5); an example flowchart illustrating creation and use of inputs to a differential log file analysis state machine (FIG. 6A); an example flowchart illustrating one possible method of processing inputs to a differential log file analysis state machine and resulting state machine analysis (FIG. 6B); an example computing device with a hardware processor and accessible machine-readable instructions that might be used to perform differential log file analysis using success patterns and a state machine (FIG. 7); a computer network infrastructure that may be used to implement all or part of the disclosed differential log file analysis techniques as well as providing an example infrastructure where an implementation of disclosed techniques may be deployed (FIG. 8); and according to one a computer processing device that may be used to implement the functions, modules, processing platforms, execution platforms, communication devices, and other methods and processes of this disclosure (FIG. 9).

Referring now to FIG. 1, functional block diagram of a distributed computer system 100 is illustrated and includes example devices and applications, each of which may generate log file entries. Distributed computer system 100 is simplified for discussion and complex networks of many devices and applications are not uncommon. Distributed computer system 100 represents one example of a possible collection and analysis process that uses automated collection, correlation, and analysis techniques to identify potential anomalies in the overall system, according to one or more disclosed implementations.

Distributed computer system 100 includes an example network appliance 102 containing a local repository 103. As mentioned above, some log file entries may be stored locally on a device or may be transmitted to a central repository upon generation. Local repository 103 represents a storage area, local to network appliance 102, where some number of log file entries (or all log file entries) may be stored prior to transmission to (or collection for) a central analysis repository. Different implementations are possible for caching and collecting log file entries and may depending on design criteria based on a function of the device or application generating log file entries.

Distributed computer system 100 also includes network communication device 105, having a local repository 106 that may be used in a similar manner to local repository 103. Network communication device 106 may be a switch, router, bridge, or the like that facilitates communication between other devices connected to one or more networks. Log file entries on network communication device 106 may represent network events, device status, or local application status (among other possibilities). Network communication device 106 represents, in this example, other types of devices that may generate log file entries even though some devices do not execute standard user application software. Accordingly, disclosed techniques for log file analysis are not limited to any particular kind of application or device or any type of connection to a specific application or device. Log file entries (or log files) may be collected periodically or transmitted from mobile devices at a time when convenient for the mobile device (e.g., in range of a network or when not in active use by an end-user).

Distributed computer system 100 also includes two computer servers that are used as an example of how some applications may execute on a single system or may be distributed across multiple systems. When applications are distributed across multiple systems (or execute in multiple threads on a single system) there may be variations in the order of messages in a log file where the variations are not representative of areas of concern. For example, if these multiple sources write to a composite log file the timing of different sources providing entries to the composite log file may be expected. Application 1 115-A (on computer server A 107) and application 1 115-B (on computer server B 110) is illustrated to represent a distributed application that executes concurrently on both computer server A 107 and computer server B 110. Because the application is distributed, in this example, multiple log file repositories may exist such as log file repository 116-A on computer server 107 and log file repository 116-B on computer server B 110.

Continuing with the example of computer server A 107 and computer server B 110, application 2 120 (and log file repository 121) is illustrated as an application that executes only on computer server A 107. Application 3 135 (and log file repository 136) is illustrated as an application that executes only on computer server B 110. As illustrated, each of computer server A 107 and computer server B 110 may have any number of applications and/or log file repositories as illustrated by application N 125, log file repository 126, application Z 140, and log file repository 141, respectively. Finally, each of computer server A 107 and computer server B 110 are illustrated to include a non-application specific device log 130-A and 130-B. As mentioned above, different numbers of log file repositories may exist to store (or temporarily store) log file entries prior to collection and analysis. Applications may be configured to write to an independent log file, a composite log file, or directly to a device log file depending on the type of log file entry being generated or based on their design criteria.

Continuing with distributed computer system 100, log collection process 150 illustrates that log files from multiple sources may be collected for correlation and analysis using disclosed differential log analysis techniques. Log process 150 may be an active collection process or a passive collection process. An active collection process may initiate collection of log file entries from sources and a passive collection process may receive information as that information is transmitted from each source. A combination of active and passive collection may be implemented with some sources transmitting information and other sources waiting for a collection to be initiated. Data repository 155 illustrates that distributed computer system 100 may include, at one or more devices, a set of information for use in differential log file analysis. This information may include the actual real-time results logs of log file entries, the above-mentioned success patterns, and possibly analysis metrics or analysis algorithms (among other data (e.g., state machine information)). Log correlation process 160 represents that data, metrics, and algorithms may be used to correlate log entries from one or more sources. For example, log correlation process may include creation of log chains and corresponding log chain identifiers as mentioned above. Log analysis process 165 illustrates that techniques to perform differential log file analysis, possibly in combination with other analysis techniques (e.g., machine learning) may be applied after (or as part of) correlation. User interface device 170 illustrates that interaction with log file analysis process 165 and sources of log file entries (e.g., the other devices of distributed computer system 100) may be provided. For example, a QA engineer may be able to use user interface device 170 to analyze automated QA test runs or a system administrator may interact with user interface device 170 to detect and identify error conditions in distributed computer system 100.

Turning to FIG. 2, block diagram 200 illustrates an example of line patterns that may be used in automated log file analysis, according to one or more disclosed implementations. These line patterns, as discussed above, may be generated automatically over time from entries received in a target system (e.g., distributed computer system 100), may be created or adjusted manually, or a combination of automated and manual generation may be used. Healthy logs 205 include a log file entry from multiple test runs. Namely, test 1 206, test 2 207, and test 3 208. Each of these log file entries may represent a different run of a same test and therefore, if all three tests are successful, may represent a starting point for automated comparison to determine what deviations in log file entries may be acceptable (and do not represent areas of concern). Line 210 indicates that success patterns may be determined from multiple “healthy” logs. Lines 215 indicate that a patter may include one or more regular expressions (or other techniques) to annotate a log file entry such that it may be used as a comparison against future log file entries to determine if an area of concern may exist. For example, a newly analyzed log file entry that does not “match” the success pattern may be an indication of error. In this context, matching refers to a match against the regular expression formed by the success pattern. Lines 220 illustrate one sample failed test log file entry. Line 230 indicates that the failed log (although it may not yet be determined to be failed until after comparison) includes an extra portion of line 235 indicated in area 236. The bold portion of line 235 matches the regular expression of the test pattern but the extra portion in area 236 may cause the system to not completely match the success pattern and thus be flagged as an area of concern (e.g., abnormal log file entry).

Referring now to FIGS. 3A-C, an example of sequence patterns 300 for use in automated log file analysis, according to one or more disclosed implementations is illustrated. In a similar manner to that described for FIG. 2 above, healthy sequences 305 represent multiple test runs of successful test. In this example, it is not a single log file entry that forms the success pattern. Test 1 produces log file entries as indicated by area 306. Test 2 produces log file entries as indicated by area 307, and test 3 produces log file entries as indicated by area 308. Line 310 indicates that a success pattern, in this case a sequence success pattern, may be produced from the multiple successful test runs. Area 315 indicates that a regular expression across multiple lines may be created by determining “allowable” variations in log file entries. Note, the variations and regular expression may be the same or different for each individual log file entry in the sequence. Line 320 indicates that a future log file set of entries (area 325) may be compared against the sequence regular expression to determine if any variations may need to be flagged for additional investigation (e.g., abnormal entries). Line 330 indicates that a “match” may be performed to identify areas not satisfying the success pattern regular expression. Lines 334 and 336 are illustrated, in this example, to pass the success pattern test, however, line 335 includes area 337 that does not match the regular expression success pattern test (that may be implemented as a state machine as discussed below) and thus area 337 may represent an area of concern for the group of log file entries.

FIG. 3B illustrates a code sample 340 that may be used to identify branches as a type of sequence pattern that may appear in a log file, according to one or more disclosed implementations. As mentioned above, code may not execute in a linear fashion. Accordingly, log file entries may have multiple successful sequence patterns. Accordingly, class 345 represents one possible method for determining a state machine to cover the multiple possible branches in a branched sequential success pattern.

FIG. 3C illustrates a code sample 350 that may be used to identify cycles as a type of sequence pattern that may appear in a log file, according to one or more disclosed implementations. As mentioned above, code may not execute in a linear fashion. Accordingly, log file entries may have multiple successful sequence patterns that represent allowable cycles in code execution. Accordingly, code sample 350 represents one possible method for determining a state machine to cover the multiple possible cycles in a cyclical sequential success pattern.

FIG. 4 illustrates a sample of information that may appear in a log file and information related to creating timing success patterns for use in automated log file analysis, according to one or more disclosed implementations. In addition to cyclical success patterns and branching success patterns, a temporal correlation between log file entries may represent a successful sequential pattern or may be used as an indication of an abnormal log file condition. As explained above, healthy sequence 405 may represent multiple test runs where each log file entry includes a time stamp of when the log file entry was generated. Area 406 represents test 1, area 407 represents test 2, and area 408 represents test 3. Line 410 indicates that a timing success pattern may be generated from a set of successful test runs. Area 415 represents a regular expression for log file entry data similar to that discussed above, however, in this case, the success pattern has been augmented with timing information. Specifically, each log entry in area 415 may include a time delta (or range of time) that represents an amount of time between successive log file entries that is acceptable. Accordingly, even if content of log file entries does not indicate a failure with respect to the regular expression match, a non-standard time deviation may be considered an indication of an area of concern. Areas of concern based on abnormal timing may also be an indication of abnormal log entries that require further investigation.

Line 420 indicates that log file entries may be considered to determine if they represent a failure (area of concern). Area 425 represents example data of a failed test run that may be used to generate data for comparison against a previously generated timing success pattern. Line 440 indicates that the results of the “match” may indicate a deviation from acceptable results as indicated in area 447 which has a timing deviation for the log file entries of area 445 when compared to the timing success pattern of 425. These types of deviations may be an indication of performance issues in a network as opposed to a specific error condition. Often, performance issues may be an indication of future failures so prompt identification and escalation to a system administrator of these types of log file entries may improve availability of a target system (e.g., distributed computer network 100).

In some implementations, statistics may be collected for line, sequence and timing patterns and a standard deviation calculated for each pattern. When compared against specific test iterations (successful or failed) it may be determined if test is ‘gracefully’ or ‘marginally’ passing based on if that test conforms to the standard deviation or not. This type of analysis may be helpful in analyzing performance and scaling issues when system load increases. A larger system (or a more heavily loaded system) may produce a higher count of log entries and larger delta time across log entries signifying system overload. Statistical information may be helpful in determining unusual spikes (or silence) in system logging signifying unusual activity that deserves attention.

As successive iterations of tests ‘pass’ in continuous integration environment under various system conditions, more log files may be generated and used to “strengthen” existing patterns. Accordingly, a comprehensive system implementation may generate new patterns when new tests are introduced, and larger sample of statistics have been collected (as described above). Overall, machine learning techniques may be used to refine performance of the disclosed differential log analysis implementation and result in an ability to automatically scale for a dynamic system environment.

FIG. 5 illustrates one possible flow chart as an example of different possible state machine implementations for use in automated log file analysis based on a differential analysis and success patterns, according to one or more disclosed implementations. The state machine, in this example implementation, represents valid known code paths in a continuous integration environment (e.g., run-time target system). Each state, represented by a node in the state machine of this example implementation, represents a log portion for analysis (e.g., one or more log file lines such as a single line to compare against a line pattern or a sequential grouping of log file entries to compare against a sequence pattern). The connections between nodes may be considered to represent sequence patterns and weights of edges may be considered to describe time taken for code to move from one state (node/log entry) to another. Individual nodes may be generated from line patterns as discussed above. Edges (connections) between nodes may be generated from sequence patterns as discussed above such that traversal of the state machine is only possible for a known success pattern (e.g., failure of state machine traversal indicates error). Weights of each edge may be used as an indication of traversal time and may be learned from timing patterns as discussed above. To create a state machine, some implementations may use a multiple number of valid log chains from successful test execution in a given target environment. That is, the patterns of success (line, sequence and timing) may be identified and consolidated into a state machine that may have attributes specific for that target environment. In some cases, attributes of a generated state machine may be portable across different environments but automatic run-time adjustment (e.g., machine learning) on a specific target environment (for at least portions of a state machine) may produce enhanced performance and accuracy.

One example for state machine implementation 550 using only successful log entries is illustrated. Flow begins at block 555 where a constructor (e.g., software code) may implement a state represented by a node in a state machine. A timing transition (e.g., timing pattern) from that state may be indicated as 1-3 seconds, as in this example, for transition to a next state. That is, the amount of time spent in a given state may have a time attribute as part of a timing success pattern. Decision 560 represents a determination if the matching of a regular expression is within bounds for a log file entry. If so, the YES prong of decision 560, flow continues to block 565 where the node may be created as part of a possible branching pattern (or an ultimate line pattern if no future branches are found). However, if not, the NO prong of decision 560 a branching pattern may be detected and created as another possible valid path for future log file entry analysis. Again, only successful test log file entries are used in the generation of a state machine, so errors will be detected based on no valid path through a generated state machine for a target test environment. The transition from block 565 to end state 570 may also have a timing transition as part of a timing pattern as illustrated (e.g., 2 seconds). Using a large number of successful test runs may provide for a state machine that covers all expected possibilities of the run-time target environment such that any deviation from these known success patterns may be escalated for further investigation. For example, by a system administrator or a QA engineer.

Referring to FIG. 6A, there is illustrated one example flowchart connecting screen snippets from different phases in a differential log file analysis state machine, according to one or more disclosed implementations. Block 605 illustrates log files from a continuous integration environment (e.g., a target environment for analysis) where information in the log files represents only successful (e.g., passed) tests. Blocks 610-1, 610-2, 610-3, and 610-4 represent four individual log chains that may have been “extracted” or de-interlaced from a single (or multiple different) log file such that related log file entries have been grouped together (e.g., correlated with each other based on a functional association). Block 625 illustrates a possible state machine that may be “built” from these successful execution paths and their corresponding log file information. Block 615 illustrates identified potential failed log file entries from a target environment and block 620 illustrates that some subset of those potentially failed log file entries may be identified after processing through the state machine of known success patterns. Thus, attention may be drawn to a subset of all potential filed log file entries. Note that in some disclosed implementations, there is no burden on an end-user (e.g., system administrator or QA engineer) to identify potential failed log files. In these implementations, log files from failed system will be provided as input to the state machine which will execute, and any state not present in state machine will be identified as a potential suspect for failure.

Referring now to FIG. 6B, a flowchart illustrates one possible method 650 that may be used to implement a differential log file analysis system similar to that illustrated in FIG. 6A. Example method 650 begins at block 655 where a differential log file analysis process may be initiated. Block 660 indicates that a plurality of log files or log files entries (e.g., from a composite log files with multiple input sources) may be extracted to form log chains. Block 665 indicates that specific log chains may be identified and supplied with a log chain identifier or other sort of key differentiator for further ease of reference. Block 670 indicates that multiple log chains may then be sorted based on a priority of importance or for further correlation to other log chains (perhaps from different sources). Block 675 indicates that log chains may then be parsed to identify the above-mentioned sequential patterns or other patterns of success for use in comparison with future log file entries. Block 680 indicates that a state machine may be generated based on the identified patterns of success. At this point a data store of information and filtering techniques may be available for deployment to a test environment such as a continuous integration environment as the target environment for this deployment.

Continuing with FIG. 6, block 685 indicates that run-time log files may be collected. For example, from QA test runs to perform automated validation testing of a software release or from run-time applications/devices on the target system. As part of the run-time implementation, generated log file entries may be processed to extract newly created log chains that may be processed through the state machine created previously. Accordingly, based on a comparison of current run-time log file entries that may include possible failed patterns an identification and escalation (e.g., alert) may be generated if the newly created log chains do not properly process through the state machine.

FIG. 7 is an example computing device 700, with a hardware processor 701, and accessible machine-readable instructions stored on a machine-readable medium 702 that may be used to support the above discussed development and execution of a differential log analysis technique based, in part, on patterns of success, according to one or more disclosed example implementations. FIG. 7 illustrates computing device 700 configured to perform the flow of method 650 as an example. However, computing device 700 may also be configured to perform the flow of other methods, techniques, functions, or processes described in this disclosure. In this example of FIG. 7, machine-readable storage medium 702 includes instructions to cause hardware processor 701 to perform blocks 655-685 discussed above with reference to FIG. 6B.

A machine-readable storage medium, such as 702 of FIG. 7, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

FIG. 8 represents a computer network infrastructure that may be used to implement all or part of the disclosed differential log file analysis techniques (e.g., using a state machine and patterns of success), according to one or more disclosed implementations. Network infrastructure 800 includes a set of networks where embodiments of the present disclosure may operate (e.g., components shown may execute a resultant differential log analysis technique as part of monitoring the network infrastructure 800 devices and applications themselves) Network infrastructure 800 comprises a customer network 802, network 808, cellular network 803, and a cloud service provider network 810. In one embodiment, the customer network 802 may be a local, private network, such as local area network (LAN) that includes a variety of network devices that include, but are not limited to switches, servers, and routers.

Each of these networks can contain wired or wireless programmable devices and operate using any number of network protocols (e.g., TCP/IP) and connection technologies (e.g., WiFi® networks, or Bluetooth®. In another embodiment, customer network 802 represents an enterprise network that could include or be communicatively coupled to one or more local area networks (LANs), virtual networks, data centers and/or other remote networks (erg., 808, 810). In the, context of the present disclosure, customer network 802 may include multiple devices configured with the disclosed event ingestion management techniques such as those described above. Also, one of the many computer storage resources in customer network 802 (or other networks shown) may be configured to store the log files individually or collectively, as well as the patterns of success for which to compare against captured log file entries as discussed above.

As shown in FIG. 8, customer network 802 may be connected to one or more client devices 804A-E and allow the client devices 804A-E to communicate with each other and/or with cloud service provider network 810, via network 808 (e.g., Internet). Client devices 804A-E may be computing systems such as desktop computer 804B, tablet computer 804C, mobile phone 804D, laptop computer (shown as wireless) 804E, and/or other types of computing systems generically shown as client device 804A.

Network infrastructure 800 may also include other types of devices generally referred to as Internet of Things (IoT) (e.g., edge IOT device 805) that may be configured to send and receive information via a network to access cloud computing services or interact with a remote web browser application (e.g., to receive information from a user).

FIG. 8 also illustrates that customer network 802 includes local compute resources 806A-C that may include a server, access point, router, or other device configured to provide for local computational resources and/or facilitate communication amongst networks and devices. For example, local compute resources 806A-C may be one or more physical local hardware devices, such as the devices configured to perform a differential log file analysis technique outlined above. Local compute resources 806A-C may also facilitate communication between other external applications, data sources (e.g., 807A and 807B), and services, and customer network 802. Local compute resource 806C illustrates a possible processing system cluster with three nodes. Of course, any number of nodes is possible, but three are shown in this example for illustrative purposes.

Network infrastructure 800 also includes cellular network 803 for use with mobile communication devices. Mobile cellular networks support mobile phones and many other types of mobile devices such as laptops etc. Mobile devices in network infrastructure 800 are illustrated as mobile phone 804D, laptop computer 804E, and tablet computer 804C. A mobile device such as mobile phone 804D may interact with one or more mobile provider networks as the mobile device moves, typically interacting with a plurality of mobile network towers 820,830, and 840 for connecting to the cellular network 803. In the context of system monitoring and event management that may produce log file entries, user alerts as to initiating further investigation of log file anomalies may be configured to provide an end-user notification. In some implementations, this notification may be provided through network infrastructure 800 directly to a system administrators cellular phone.

Although referred to as a cellular network in FIG. 8, a mobile device may interact with towers of more than one provider network, as well as with multiple non-cellular devices such as wireless access points and routers (e.g., local compute resources 806A-C). In addition, the mobile devices may interact with other mobile devices or with non-mobile devices such as desktop computer 804B and various types of client device 804A for desired services.

FIG. 8 illustrates that customer network 802 is coupled to a network 808. Network 808 may include one or more computing networks available today, such as other LANs, wide area networks (WAN), the Internet, and/or other remote networks, in order to transfer data between client devices 804A-D and cloud service provider network 810. Each of the computing networks within network 808 may contain wired and/or wireless programmable devices that operate in the electrical and/or optical domain.

In FIG. 8, cloud service provider network 810 is illustrated as a remote network (e.g., a cloud network) that is able to communicate with client devices 804A-E via customer network 802 and network 808. The cloud service provider network 810 acts as a platform that provides additional computing resources to the client devices 804A-E and/or customer network 802. In one embodiment, cloud service provider network 810 includes one or more data centers 812 with one or more server instances 814. Each of these resources may work together with non-cloud resources to provide execution of or interface to deployed log file collection and analysis techniques as discussed herein.

FIG. 9 illustrates a computer processing device 900 that may be used to implement the functions, modules, processing platforms, execution platforms, communication devices, and other methods and processes of this disclosure. For example, computing device 900 illustrated in FIG. 9 could represent a client device or a physical server device and include either hardware or virtual processor(s) depending on the level of abstraction of the computing device. In some instances (without abstraction), computing device 900 and its elements, as shown in FIG. 9, each relate to physical hardware. Alternatively, in some instances one, more, or all of the elements could be implemented using emulators or virtual machines as levels of abstraction. In any case, no matter how many levels of abstraction away from the physical hardware, computing device 900 at its lowest level may be implemented on physical hardware.

Computing device 900 may be used to implement any of the devices that are used by system administrators or QA engineers to collect and analyze log files (e.g., to create or execute the disclosed differential log file analysis using a state machine of known success patterns). As also shown in FIG. 9, computing device 900 may include one or more input devices 930, such as a keyboard, mouse, touchpad, or sensor readout (e.g., biometric scanner) and one or more output devices 915, such as displays, speakers for audio, or printers. Some devices may be configured as input/output devices also (e.g., a network interface or touchscreen display).

Computing device 900 may also include communications interfaces 925, such as a network communication unit that could include a wired communication component and/or a wireless communications component, which may be communicatively coupled to processor 905. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 9, computing device 900 includes a processing element such as processor 905 that contains one or more hardware processors, where each hardware processor may have a single or multiple processor core. In one embodiment, the processor 905 may include at least one shared cache that stores data (e.g., computing instructions) that are utilized by one or more other components of processor 905. For example, the shared cache may be a locally cached data stored in a memory for faster access by components of the processing elements that make up processor 905. In one or more embodiments, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 9, the processing elements that make up processor 905 may also include one or more of other types of hardware processing components, such as graphics processing units (GPU), application specific integrated circuits (ASICs), field-programmable gate arrays (FPGAs), and/or digital signal processors (DSPs).

FIG. 9 illustrates that memory 910 may be operatively and communicatively coupled to processor 905. Memory 910 may be a non-transitory medium configured to store various types of data. For example, memory 910 may include one or more storage devices 920 that comprise a non-volatile storage device and/or volatile memory. Volatile memory, such as random-access memory (RAM), can be any suitable non-permanent storage device. The non-volatile storage devices 920 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 920 may be used to store overflow data if allocated RAM is not large enough to hold all working data. The non-volatile storage devices 920 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 905. In one embodiment, the compiling process of the software program may transform program code written in a programming language to another computer language such that the processor 905 is able to execute the programming code. For example, the compiling process of the software program may generate an executable program that provides encoded instructions (e.g., machine code instructions) for processor 905 to accomplish specific, non-generic, particular computing functions.

After the compiling process, the encoded instructions may then be loaded as computer executable instructions or process steps to processor 905 from storage device 920, from memory 910, and/or embedded within processor 905 (e.g., via a cache or on-board ROM). Processor 905 may be configured to execute the stored instructions or process steps in order to perform instructions or process steps to transform the computing device into a non-generic, particular, specially programmed machine or apparatus. Stored data, e.g., data stored by a storage device 920, may be accessed by processor 905 during the execution of computer executable instructions or process steps to instruct one or more components within the computing device 900.

A user interface (e.g., output devices 915 and input devices 930) can include a display, positional input device (such as a mouse, touchpad, touchscreen, or the like), keyboard, or other forms of user input and output devices. The user interface components may be communicatively coupled to processor 905. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 900 may comprise other components well known in the art, such as sensors, powers sources, and/or analog-to-digital converters, not explicitly shown in FIG. 9.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . ” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A computer-implemented method of differential log file analysis using a computer device, the method comprising:
obtaining a first set of one or more log file entries representative of a plurality of successful test executions of a computer process;
determining acceptable deviations between log file entries associated with different instances of the plurality of successful test executions;
creating a pattern matching representation for acceptable deviations;
obtaining a second set of one or more log file entries representative of a run-time execution of the computer process;
automatically comparing the second set of one or more log file entries with the pattern matching representation; and
identifying any deviations as identified by the comparison as representative of an execution abnormality of the computer process.

2. The method of claim 1, further comprising:
creating an alert based on an identified deviation; and
initiating transmission of the alert to a user-interface device.

3. The method of claim 1, wherein the pattern matching representation includes regular expressions to allow for acceptable deviations.

4. The method of claim 1, wherein automatically comparing the second set of one or more log files with the pattern matching representation comprises processing the second set of one or more log file entries through an automatically generated state machine.

4. The method of claim 1, wherein the pattern matching representation is based on a line pattern.

5. The method of claim 1, wherein the pattern matching representation is based on a sequence pattern, the sequence pattern including an association of multiple log file entries to each other.

6. The method of claim 5, wherein the sequence pattern is a branching sequence pattern or a cyclical sequence pattern.

7. The method of claim 1, wherein the matching pattern is automatically adjusted using machine learning techniques at run-time for a target system based on an indication that a set of deviations identified as the execution abnormality are acceptable.

8. The method of claim 1, wherein the matching pattern includes a timing pattern in addition to a sequence pattern, the timing pattern indicating a time for transition between nodes of a state machine representing the matching pattern.

9. A computer device, comprising:
a hardware processor;
one or more storage areas accessible to the first hardware processor; and
an instruction memory area communicatively coupled to the first hardware processor, wherein the instruction memory area stores instructions, that when executed by the first hardware processor, cause the first hardware processor to:
obtain a first set of one or more log file entries representative of a plurality of successful test executions of a computer process;
determine acceptable deviations between log file entries associated with different instances of the plurality of successful test executions;
create a pattern matching representation for acceptable deviations;
obtain a second set of one or more log file entries representative of a run-time execution of the computer process;
automatically compare the second set of one or more log file entries with the pattern matching representation; and
identify any deviations as identified by the comparison as representative of an execution abnormality of the computer process.

10. The computer device of claim 9, wherein the instruction memory area further comprises instructions, that when executed by the first hardware processor, cause the first hardware processor to:
identify one or more log chains from multiple sources of log file entries, the one or more log chains providing an indication of sequential relationship between multiple log file entries.

11. The computer device of claim 10, wherein the one or more log chains are used to create the second set of one or more log file entries for comparing against the pattern matching representation.

12. The computer device of claim 9, wherein the pattern matching representation is based on a line pattern or a sequence pattern.

13. The computer device of claim 12, wherein the sequence pattern includes a branching sequence pattern or a cyclical sequence pattern.

14. The computer device of claim 13, wherein the sequence pattern further includes a timing pattern the timing pattern indicating a time for transition between nodes of a state machine representing the matching pattern.

15. A non-transitory computer readable medium comprising computer executable instructions stored thereon that when executed by one or more hardware processors, cause the one or more hardware processors to:
obtain a first set of one or more log file entries representative of a plurality of successful test executions of a computer process;
determine acceptable deviations between log file entries associated with different instances of the plurality of successful test executions;
create a pattern matching representation for acceptable deviations;
obtain a second set of one or more log file entries representative of a run-time execution of the computer process;
automatically compare the second set of one or more log file entries with the pattern matching representation; and
identify any deviations as identified by the comparison as representative of an execution abnormality of the computer process.

16. The non-transitory computer readable medium of claim 15, wherein the instructions stored thereon further comprise instructions, that when executed by the one or more hardware processors, cause the one or more hardware processors to:
initiate collection of the second set of one or more log file entries from a device remote to the one or more hardware processors.

17. The non-transitory computer readable medium of claim 16, wherein the instructions stored thereon further comprise instructions, that when executed by the one or more hardware processors, cause the one or more hardware processors to:
periodically initiate collection of the second set of one or more log file entries from a set of devices remote to the one or more hardware processors, the set of devices collectively executing a single distributed application program.

18. The non-transitory computer readable medium of claim 15, wherein the instructions stored thereon further comprise instructions, that when executed by the one or more hardware processors, cause the one or more hardware processors to:
periodically initiate collection of the second set of one or more log file entries from a set of devices remote to the one or more hardware processors, the set of devices collectively executing a single distributed application program; and
receive unsolicited log file entries that are included in the second set of one or more log files entries prior to comparison with the pattern matching representation.

19. The non-transitory computer readable medium of claim 18, the instructions stored thereon further comprise instructions, that when executed by the one or more hardware processors, cause the one or more hardware processors to:
automatically create one or more log chains from the second set of one or more log file entries, the one or more log chains providing an indication of sequential relationship between multiple log file entries.

20. The non-transitory computer readable medium of claim 18, the instructions stored thereon further comprise instructions, that when executed by the one or more hardware processors, cause the one or more hardware processors to:
create the pattern matching representation to include a combination of line patterns, sequence patterns, cyclical patterns, and timing patterns.
